(19) United States
(12) Patent Application Publication
(10) Pub. No.: US 2023/0024906 A1
(43) Pub. Date: Jan. 26, 2023

(54) RADIO COMMUNICATION APPARATUS

(71) Applicant: JVCKENWOOD Corporation, Yokohama-shi (JP)

(72) Inventors: Takashi SHIMIZU, Yokohama-shi (JP); Eiichi Hosono, Yokohama-shi (JP)

(21) Appl. No.: 17/866,306

(22) Filed: Jul. 15, 2022

(30) Foreign Application Priority Data
Jul. 21, 2021 (JP) 2021-120604

(51) Int. Cl. H04W 72/10

(52) U.S. Cl. CPC H04W 72/10

(57) ABSTRACT

A radio communication apparatus includes: a first radio device; a second radio device; and an operation unit, in which: in the first radio device, at least one of a plurality of channels usable by the first radio device is defined as a first priority channel, the first priority channel being a channel on which a radio wave is preferentially detected; and when a signal is transmitted on a channel other than the first priority channel in response to an operation performed on the first radio device based on an input from the user received through the operation unit, channel information indicating the first priority channel is transmitted to the second radio device, and the second radio device starts detecting a radio wave on the channel indicated by the channel information.

### CROSS REFERENCE TO RELATED APPLICATION

This application is based upon and claims the benefit of priority from Japanese patent application No. 2021-120604, filed on Jul. 21, 2021, the disclosure of which is incorporated herein in its entirety by reference.

### BACKGROUND

The present disclosure relates to a radio communication apparatus.

As disclosed in Japanese Patent No. 6861861, a technique for broadcasting a voice to at least one radio terminal through radio waves on a specific channel (a specific channel, a specific frequency) in a business radio such as a police radio has been known.

However, in the related art, in some cases, for example, when transmission is being performed on a given channel, radio waves transmitted on other channels cannot be detected.

### SUMMARY

In an aspect according to the present disclosure, a radio communication apparatus includes: a first radio device; a second radio device; and an operation unit configured to operate the first or second radio device based on an input received from a user and transmit information between the first and second radio devices, in which in the first radio device, at least one of a plurality of channels usable by the first radio device is defined as a first priority channel, the first priority channel being a channel on which a radio wave is preferentially detected, and when a signal is transmitted on a channel other than the first priority channel in response to an operation performed on the first radio device based on an input from the user received through the operation unit, channel information indicating the first priority channel is transmitted to the second radio device, and the second radio device starts detecting a radio wave on the channel indicated by the channel information.

### BRIEF DESCRIPTION OF THE DRAWINGS

The above and other aspects, advantages and features will be more apparent from the following description of certain embodiments taken in conjunction with the accompanying drawings, in which:

FIG. 1 shows an example of a configuration of a radio communication system according to an embodiment;

FIG. 2 shows an example of a configuration of a radio communication apparatus according to an embodiment;

FIG. 3 shows an example of a hardware configuration of a control device according to an embodiment;

FIG. 4 shows an example of a configuration of a control device according to an embodiment;

FIG. 5 is a sequence diagram showing an example of processes performed by a radio communication apparatus according to an embodiment; and

FIG. 6 is a sequence diagram showing an example of processes performed by a radio communication apparatus according to an embodiment.

### DETAILED DESCRIPTION

The principle of the present disclosure will be described with reference to several example embodiments. It should be understood that these embodiments are described only for an illustrative purpose and will assist those skilled in the art in understanding and carrying out the present disclosure without suggesting any limitations in regard to the scope of the disclosure. Disclosures described in this specification can also be implemented in a variety of ways other than those described below.

In the following description and the claims, unless otherwise defined, all technical and scientific terms used in this specification have the same meanings as those generally understood by those skilled in the technical field to which the present disclosure belongs.

Embodiments will be described hereinafter with reference to the drawings.

### <System Configuration>

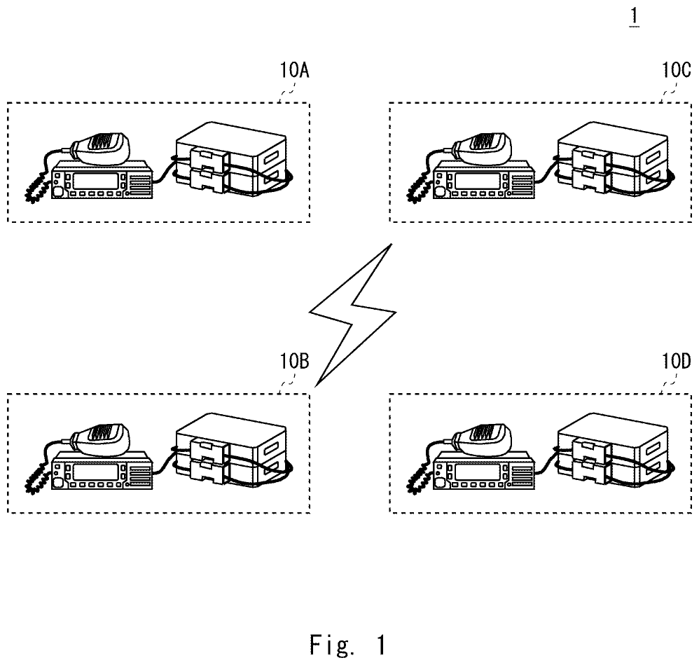

A configuration of a radio communication system 1 according to an embodiment will be described with reference to FIG. 1. FIG. 1 shows an example of the configuration of the radio communication system 1 according to an embodiment. In the example shown in FIG. 1, the radio communication system 1 includes a radio communication apparatus 10A, a radio communication apparatus 10B, a radio communication apparatus 10C, a radio communication apparatus 10D, and so on. (Hereinafter, when it is unnecessary to distinguish one radio communication apparatus from another, they are simply referred to as “radio communication apparatuses 10”). Note that the number of radio communication apparatuses 10 is not limited to the number in the example shown in FIG. 1.

Each of the radio communication apparatuses 10 (hereinafter simply referred to as the radio communication apparatus 10) is a terminal that performs communication by a dedicated radio (a business radio) for conveying business information, such as a police radio, a fire radio, a disaster prevention radio, a railway radio, a ship radio, a defense-force radio, and the like. The radio communication apparatus 10 may perform radio broadcasting on a predetermined channel (at a predetermined frequency) directly or through a relay station(s).

The radio communication apparatus 10 may be used, for example, for police work, fires, emergencies, administrative purposes, disaster relief, mountain rescue, coast guard work, taxi operator work, truck operator work, and the like. The radio communication apparatus 10 may be installed in a mobile body such as a vehicle and a ship, or may be carried by a user.

The radio communication apparatus 10 intermittently receives (i.e., scans) each of a plurality of predetermined channels, receives a voice signal transmitted from other radio communication apparatuses 10 on one of the plurality of channels, and outputs the received voice signal (i.e., a voice represented by the received voice signal) from a speaker. Further, the communication apparatus 10 modulates a signal representing a voice such as a voice of a user collected by a microphone and transmits the modulated signal on one of the plurality of channels designated (selected) by the user.

### <Configuration of Radio Communication Apparatus 10>

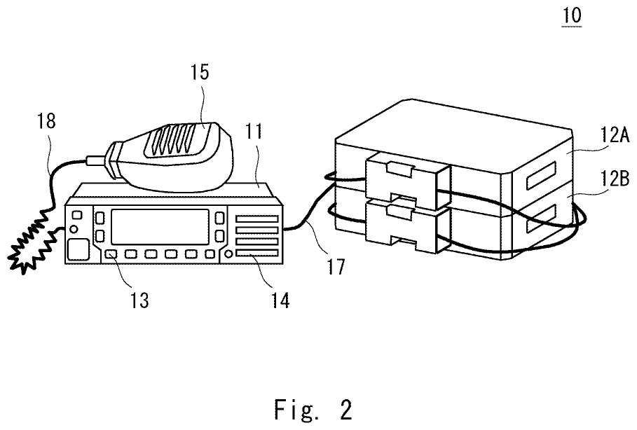

Next, a configuration of the radio communication apparatus 10 according to the embodiment will be described with reference to FIG. 2. FIG. 2 shows an example of the configuration of the radio communication apparatus 10 according to the embodiment. In the example shown in FIG. 2, the radio communication apparatus 10 includes a control device 11, a radio device 12A, a radio device 12B, an operation unit 13, a speaker 14, and a microphone 15. Note that when it is unnecessary to distinguish between the radio devices 12A and 12B, they are simply referred to as “radio devices 12”. Note that the number of radio devices 12 is not limited to the number in the example shown in FIG. 2.

The control device 11 controls the whole radio communication apparatus 10. In the example shown in FIG. 2, at least a part of the operation unit 13 and the speaker 14 are disposed inside the housing of the control device 11. Further, at least a part of the operation unit 13 may be disposed inside the housing of the microphone 15. In the example shown in FIG. 2, the control device 11 is connected to the radio devices 12 through cables 17. Further, the control device 11 is connected to the microphone 15 through a cable 18.

Each of the radio devices 12 (hereinafter simply referred to as the radio device 12) includes at least one antenna, an analog-to-digital conversion circuit, and the like. The radio device 12 successively scans (intermittently receives) radio waves on a plurality of preset (i.e., predetermined) channels. Then, when the radio device 12 detects a radio wave on one of the plurality of channels, it outputs a voice signal demodulated from a signal received on this channel to the control device 11 and makes the control device 11 output the voice signal (i.e., a voice represented by the voice signal) from the speaker 14. Note that it is assumed that the radio devices 12A and 12B are configured so as to receive radio waves on channels different from each other.

### <Hardware Configuration>

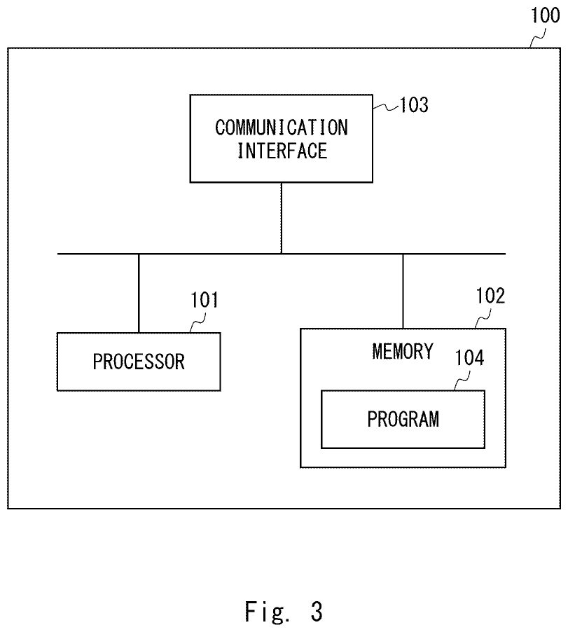

FIG. 3 shows an example of a hardware configuration of the control device 11 according to the embodiment. In the example shown in FIG. 3, the control device 11 (a computer 100) includes a processor 101, a memory 102, and a communication interface 103. These components may be connected to each other by a bus or the like. The memory 102 stores at least a part of a program 104. The communication interface 103 includes an interface necessary for communication with other network elements.

As the program 104 is executed by cooperation of the processor 101, the memory 102, and the like, at least one of the processes in the embodiment according to the present disclosure is performed by the computer 100. The memory 102 may be any type of memory suitable for a network using a local technology. The memory 102 may be, by way of a non-limiting example, a non-transitory computer readable storage medium. Further, the memory 102 may be implemented by using an arbitrary suitable data storage technology, such as a semiconductor-based memory device, a magnetic memory device and system, an optical memory device and system, a fixed memory, and a removable memory. Although only one memory 102 is shown in the computer 100, several physically different memory modules may be included in the computer 100. The processor 101 may be any type of computer. The processor 101 may include at least one of a general purpose computer, a dedicated computer, a microprocessor, a digital signal processor (DSP: Digital Signal Processor), and, as a non-limiting example, a processor based on a multi-core processor architecture. The computer 100 may include a plurality of processors, such as an application specific integrated circuit chip that is temporally dependent on a clock by which the main processor is synchronized.

An embodiment according to the present disclosure may be implemented by hardware or a dedicated circuit(s), software, logic, or any combination thereof. In some aspects, the present disclosure may be implemented by hardware, and in others aspect, the present disclosure may be implemented by firmware or software that can be executed by a controller, a microprocessor, or other computing devices.

Further, the present disclosure provides at least one computer program product tangibly stored in a non-transitory computer readable storage medium. The computer program product includes computer executable instructions, such as instructions included in program modules, is executed by a device on a real or virtual processor of interest, and thereby performs a process or method according to the present disclosure. The program modules include routines, programs, libraries, objects, classes, components, data structures, and the like by which specific tasks are performed and/or specific abstract data types are implemented. The functions of the program modules may be combined or divided among the program modules as desired in various embodiments. The machine executable instructions of the program modules can be executed locally or in distributed devices. In the distributed devices, the program modules can be disposed on both local and remote storage media.

A program code(s) for implementing a method according to the present disclosure may be written in any combination of at least one programming languages. Such program codes are provided to a processor or controller of a general purpose computer, a dedicated computer, or other programmable data processing devices. As the program code is executed by the processor or controller, the functions/operations in the flowchart and/or the block diagram to be implemented are performed. The program code is executed entirely on a machine, partially on a machine, as a standalone software package, partially on a machine, partially on a remote machine, or entirely on a remote machine or server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Compact Disc Read Only Memory), CD-R (Compact Disc Recordable), CD-R/W (Compact Disc Rewritable), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a radio communication line.

### <Configuration>

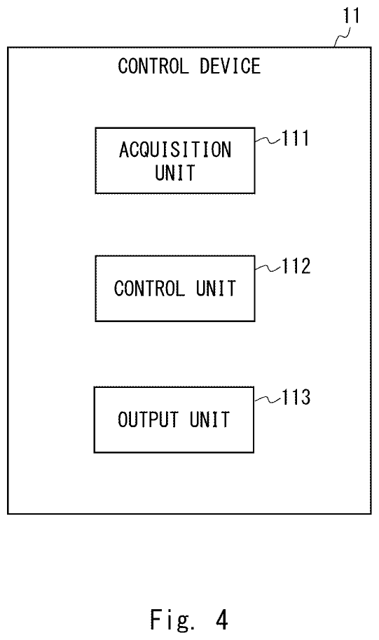

A configuration of the control device 11 according to the embodiment will be described with reference to FIG. 4. FIG. 4 shows an example of the configuration of the control device 11 according to the embodiment. In the example shown in FIG. 4, the control device 11 includes an acquisition unit 111, a control unit 112, and an output unit 113. These units (i.e., these components) may be implemented by cooperation of at least one program installed in the control device 11 and hardware such as the processor 101, the memory 102, and the like of the control device 11.

The acquisition unit 111 acquires various types of information from a storage unit disposed inside the control device 11, the operation unit 13, or an external apparatus such as the radio device 12. The control unit 112 controls each of the units (i.e., each of the components) of the radio communication apparatus 10. The output unit 113 outputs various types of information to an external apparatus such as the radio device 12 according to an instruction from the control unit 112.

### <Process>

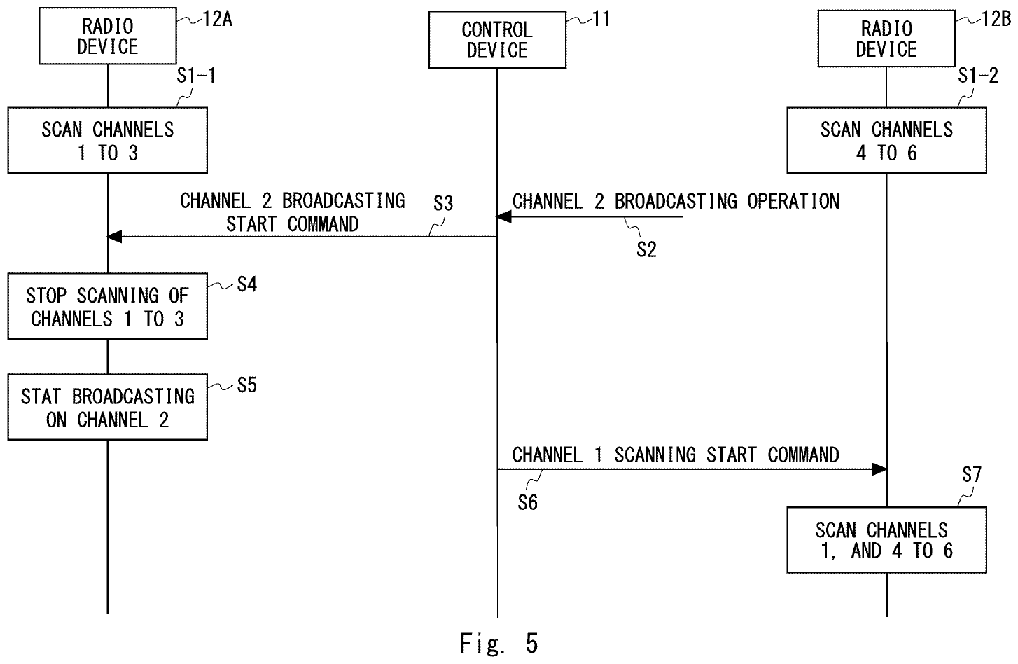

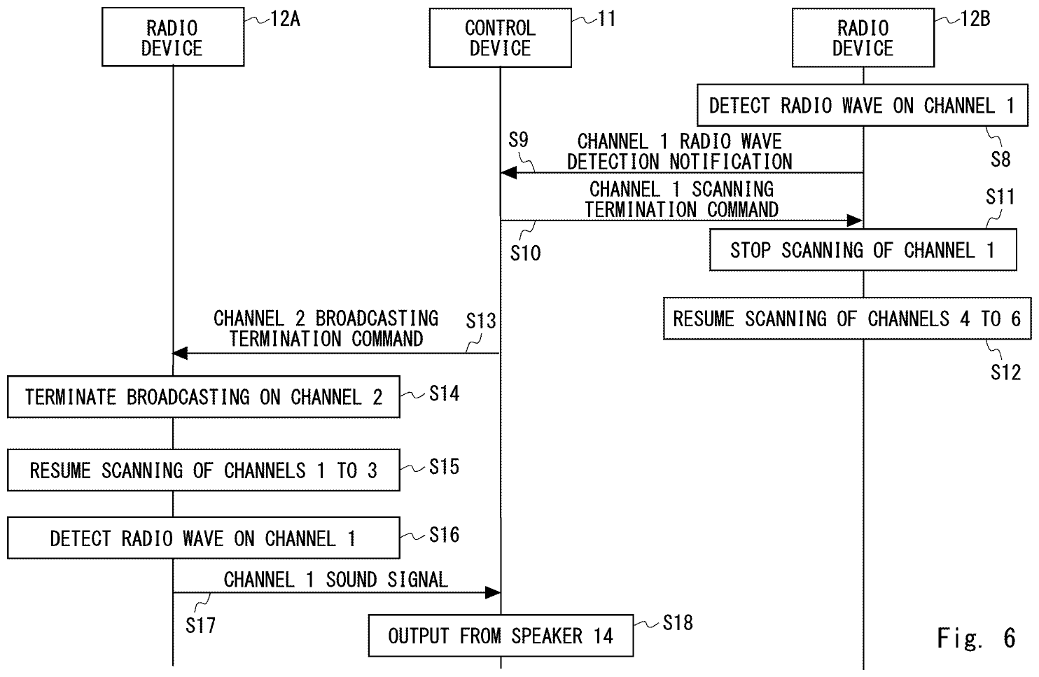

Next, an example of processes performed by the radio communication apparatus 10 according to the embodiment will be described with reference to FIGS. 5 and 6. FIGS. 5 and 6 show a sequence diagram showing an example of processes performed by the radio communication apparatus 10 according to the embodiment. Note that the order of processes described below may be changed as appropriate. Further, at least one of the below-shown processes may be omitted.

In a step S1-1, the radio device 12A starts scanning a plurality of preset (i.e., predetermined) channels. As a result, when a radio wave is detected in one of the plurality of channels, a voice signal (i.e., a voice represented by a voice signal) that is received on this channel and demodulated is output from the speaker 14.

In the following description, it is assumed that a channel 1, a channel 2, and a channel 3 are set as channels to be scanned for the radio device 12A. Note that a priority may be defined for each of the channels by a user or the like. In the following description, it is assumed that the order of priorities of the chancels 1, 2 and 3 is as follows: the channel 1 (high priority), the channel 2 (intermediate priority), and the channel 3 (low priority). In this case, for example, the channel 1 may be a channel for receiving a signal from a command center. Further, the channel 2 may be a channel for transmitting and receiving voices in a group consisting of a relatively small number of members including the user of the radio communication apparatus 10.

Further, in a step S1-2, the radio device 12B starts scanning a plurality of preset channels. As a result, when a radio wave is detected in one of the plurality of channels, a voice signal (i.e., a voice represented by a voice signal) that is received on this channel and demodulated is output from the speaker 14. In the following description, it is assumed that a channel 4, a channel 5, and a channel 6 are set as channels to be scanned for the radio device 12B. Note that the processes in the steps S1-1 and S1-2 may be performed, for example, when the radio communication apparatus 10 is powered on.

Next, the acquisition unit 111 of the control device 11 receives an operation for starting broadcasting on the channel 2 from the user through the operation unit 13 (Step S2). Note that the operation unit 13 may receive, for example, an operation for designating the channel 2 and an operation for instructing to start broadcasting. The operation for instructing to start broadcasting may be, for example, an operation (i.e., an action) of holding down (i.e., keep pressing down for a while) a button disposed on the housing of the microphone 15. Note that the control device 11 may continue the broadcasting on the designated channel while the button is held down (i.e., is kept pressed down), and stop the broadcasting on the designated channel when the holding-down of the button is stopped (i.e., the button is released).

Next, the output unit 113 of the control device 11 transmits a command for starting broadcasting on the channel 2 to the radio device 12A in response to an operation performed on the operation unit 13 by the user (Step S3). Next, upon receiving the command, the radio device 12A stops the scanning of the channels 1, 2 and 3 (Step S4).

Next, the radio device 12A starts broadcasting on the channel 2 (Step S5). Note that the radio device 12A transmits a sound collected by the microphone 15 through radio waves on the channel 2. In this way, for example, the user of the radio communication apparatus 10 can convey a voice to a user(s) of another radio communication apparatus(es) 10 by using a simplex channel.

Next, the output unit 113 of the control device 11 transmits a command (channel information) for starting the scanning of the channel 1 (the first priority channel) having a priority higher than that of the channel 2 to the radio device 12B (Step S6). Note that the control device 11 does not allow the radio device 12B to start scanning the channel 3 having a priority lower than that of the channel 2. In this way, for example, it is possible, when a voice (i.e., a signal representing a voice) is being transmitted on a channel having a certain priority (certain importance), to prevent a sound on any channel having a priority lower than that of the aforementioned channel (i.e., the channel having the certain priority) from being output. Note that the control device 11 does not allow the radio device 12B to start scanning any channel having a priority lower than the priority of the channel on which the broadcasting is started by the radio device 12A. Therefore, for example, when broadcasting on the channel 1 is started, the radio device 12B is prevented from scanning the channels 2 and 3. To do so, the control device 11 may refrain from transmitting a command. Alternatively, the control device 11 may prevent information about any channel to be scanned from being contained in the command. Further, for example, when broadcasting on the channel 3 is started, the control device 11 makes the radio device 12B scan the channels 1 and 2.

Next, when the radio device 12B receives the aforementioned command, it starts scanning, in addition to the channels 4, 5 and 6, the channel 1 (the first priority channel) which is included in the channel information (i.e., information about which (i.e., about the channel 1) is contained in the channel information) transmitted from the radio device 12A (Step S7). Note that the radio communication apparatus 10 may perform the processes in the steps S6 and S7 in parallel with (i.e., simultaneously with) the processes in the steps S3 to S5. Alternatively, the radio communication apparatus 10 may perform the processes in the steps S6 and S7 before the processes in the steps S3 to S5.

Processes that are performed in the case where after the processes up to the step S7 are performed, broadcasting on the channel 1 is performed by another communication apparatus 10 while the radio device 12A is performing broadcasting on the channel 2 will be described hereinafter. Next, the radio device 12B detects a radio wave on the channel 1 (Step S8). Next, the radio device 12B transmits a notification indicating that it has detected the radio wave on the channel 1 to the control device 11 (Step S9).

Next, upon receiving the notification, the output unit 113 of the control device 11 transmits a command for terminating the scanning of the channel 1 to the radio device 12B (Step S10). Next, upon receiving this command, the radio device 12B stops the scanning of the channel 1 (Step S11), and resumes the scanning of the preset channels 4, 5 and 6 (Step S12).

Next, the output unit 113 of the control device 11 transmits a command for terminating the broadcasting on the channel 2 to the radio device 12A (Step S13). Note that the output unit 113 of the control device 11 may notify the user about a message indicating that the broadcasting on the channel 2 will be terminated through a display of the operation unit 13 or the speaker 14 thereof.

Next, upon receiving the aforementioned command, the radio device 12A stops the broadcasting on the channel 2 (Step S14), and resumes the scanning of the preset channels 1, 2 and 3 (Step S15). Note that the radio communication apparatus 10 may perform the processes in the steps S13 to S15 in parallel with (i.e., simultaneously with) the processes in the steps S10 to S12. Alternatively, the radio communication apparatus 10 may perform the processes in the steps S13 to S15 before the processes in the steps S10 to S12.

Next, the radio device 12A detects a radio wave on the channel 1 (Step S16), and transmits a voice signal that is received on the channel 1 and demodulated to the control device 11 (Step S17). Next, the output unit 113 of the control device 11 makes the speaker 14 output the received voice signal (i.e., a voice represented by the received voice signal) (Step S18).

In the related art, in a radio communication apparatus that transmits and receives a voice on a plurality of channels according to a semi-duplex technique by using an FDMA (Frequency-Division Multiple Access) communication mode, when broadcasting is being performed on a given channel, scanning of each of the other channels is stopped. In this way, for example, it is possible to reduce the number of components such as antennas. Therefore, when broadcasting is being performed on a given channel and a voice is transmitted on another channel, a radio wave in the other channel cannot be detected. Therefore, for example, a user may miss (i.e., fail to hear) a voice (e.g., a speech) transmitted on a channel having a priority higher than that of a channel on which a voice (e.g., a speech) uttered by the user is being transmitted. In contrast, according to the present disclosure, for example, it is possible to reduce the possibility that a user may miss, when broadcasting is being performed on a given channel, a voice transmitted on a channel having a priority higher than that of the given channel.

Further, in the related art, in some cases, when a radio communication apparatus that transmits and receives voices on a plurality of channels according to a semi-duplex technique is receiving a voice on one channel, at least one other channel (e.g., a channel that has a priority higher than that of the one channel on which the voice is being received) is intermittently scanned. Then, in some cases, when the radio communication apparatus receives a voice on another channel having a higher priority while it is receiving the voice on the one channel, the radio communication apparatus stops the receiving on the one channel and starts receiving on the other channel. In such cases, the speaker (e.g., the user) who is sending the voice on the one channel cannot recognize that other users are not listening (i.e., cannot listen) to his/her voice. In contrast, according to the present disclosure, for example, a user can, when his/her radio communication apparatus is broadcasting on one channel, listen to a voice on another channel having a higher priority, so that he/she can stop the speech on the one channel. Therefore, it is possible to reduce the possibility that the user mistakenly recognizes that he/she has conveyed information to other users on the one channel.

Note that when the operation unit 13 receives an operation for terminating the broadcasting on the channel 2 from the user after the processes up to the step S7 have been performed, the control device 11 transmits a command for terminating the broadcasting on the channel 2 to the radio device 12A. Then, the radio device 12A terminates the broadcasting on the channel 2, and starts scanning the channels 1, 2 and 3. Further, the control device 11 transmits a command for terminating the scanning of the channel 2 to the radio device 12B. Then, the radio device 12B terminates the scanning of the channel 2 and continues the scanning of the channels 4, 5 and 6.

Note that, in the above-described example, when the radio device 12B detects a signal on the channel 1, which is the priority channel of the radio device 12A, the radio device 12B stops the transmission by the radio device 12A. However, the radio device 12B may demodulate the signal on the channel 1, i.e., the signal on the priority channel of the radio device 12A and transmit the voice signal (i.e., the demodulated signal) to the control device 11 while maintaining the transmission by the radio device 12A.

### <Modified Example>

Although the control device 11 may be an apparatus included (i.e., housed) in one housing, the control device 11 according to the present disclosure is not limited to this example. Each of the units (i.e., each of the components) of the control device 11 may be implemented, for example, by cloud computing formed by at least one computer. Such a control device is also included in (i.e., regarded as) an example of the “control device” according to the present disclosure. Further, the control device 11 may be configured so that at least one of the processes performed by the control device 11 may be performed by the radio device 12.

Note that the present disclosure is not limited to the above-described embodiments, and they may be modified as appropriate without departing from the scope and spirit of the disclosure. According to the embodiment, for example, when transmission is being performed on a given channel, a radio wave transmitted on another channel can be detected.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A radio communication apparatus comprising:
a first radio device;
a second radio device; and
an operation unit configured to operate the first or second radio device based on an input received from a user and transmit information between the first and second radio devices, wherein
in the first radio device, at least one of a plurality of channels usable by the first radio device is defined as a first priority channel, the first priority channel being a channel on which a radio wave is preferentially detected, and
when a signal is transmitted on a channel other than the first priority channel in response to an operation performed on the first radio device based on an input from the user received through the operation unit, channel information indicating the first priority channel is transmitted to the second radio device, and the second radio device starts detecting a radio wave on the channel indicated by the channel information.

2. The radio communication apparatus according to claim 1, wherein
at least one of a plurality of channels usable by the second radio device is set as a second priority channel in the second radio device, the second priority channel being different from a priority channel which is set in the first radio device and on which a radio wave is preferentially detected, and
when the second radio device receives the channel information, the second radio device detects radio waves on both the second priority channel and the first priority channel which is included in the channel information and set in the first radio device.

3. The radio communication apparatus according to claim 2, wherein when a radio wave on the first priority channel is detected by the second radio device, the second radio device outputs information indicating that the radio wave on the first priority channel has been detected to the first radio device, and then the first radio device stops transmission of a radio wave on any channel other than the first priority channel, starts receiving a radio wave on the first priority channel, and outputs information indicating that the transmission of the radio wave has been stopped to the operation unit.

4. The radio communication apparatus according to claim 2, wherein when a radio wave on the first priority channel is detected by the second radio device, the second radio device outputs information indicating that the radio wave on the first priority channel has been detected to the first radio device, and starts receiving a radio wave on the first priority channel.

5. The radio communication apparatus according to claim 1, wherein when the first radio device starts transmitting a radio wave on the first priority channel, the first radio device does not transmit the channel information to the second radio device.
